(19) United States
(12) Patent Application Publication
(10) Pub. No.: US 2016/0095283 A1
(43) Pub. Date: Apr. 7, 2016

(54) Protective rod for landscape

(71) Applicant: Jean-Pierre Bergeron, Longueuil (CA)

(72) Inventor: Jean-Pierre Bergeron, Longueuil (CA)

(21) Appl. No.: 14/847,006

(22) Filed: Sep. 8, 2015

(30) Foreign Application Priority Data
Oct. 1, 2014 (GB) 1417357.9

(51) Int. Cl. A01G 13/00

(52) U.S. Cl. CPC A01G 13/00

(57) ABSTRACT

A protective rod for landscape is comprised of a bent piece consisting of a horizontal, above ground member defining a given length, and a pair of anchor members extending perpendicularly from each opposite ends of the horizontal member so as to define a given height.

### FIELD OF THE INVENTION

The present invention relates generally to shielding and protective elements but more particularly to a protective rod for landscape.

### BACKGROUND OF THE INVENTION

During winter, snow removing equipment can wreak havoc on front lawns, especially devices used for clearing the sidewalk. The plow can accidentally go off track and scoop up frozen lawn under the snow or any type of landscaping such as flower beds. There has to be a simple way of preventing that.

### SUMMARY OF THE INVENTION

In view of the foregoing disadvantages inherent in the known devices now present in the prior art, the present invention, which will be described subsequently in greater detail, is to provide objects and advantages which are:

To provide for a protective rod for landscape.

In order to do so, the invention comprises a bent piece consisting of a horizontal, above ground member defining a given length, and a pair of anchor members extending perpendicularly from each opposite ends of the horizontal member so as to define a given height.

The anchor members have generally pointy ends that are planted in the soil of an area to be protected.

The rods are made of metal or polymer.

There has thus been outlined, rather broadly, the more important features of the invention in order that the detailed description thereof that follows may be better understood, and in order that the present contribution to the art may be better appreciated. There are additional features of the invention that will be described hereinafter and which will form the subject matter of the claims appended hereto.

In this respect, before explaining at least one embodiment of the invention in detail, it is to be understood that the invention is not limited in its application to the details of construction and to the arrangements of the components set forth in the following description or illustrated in the drawings. The invention is capable of other embodiment and of being practiced and carried out in various ways. Also, it is to be understood that the phraseology and terminology employed herein are for the purpose of description and should not be regarded as limiting.

As such, those skilled in the art will appreciate that the conception, upon which this disclosure is based, may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

These together with other objects of the invention, along with the various features of novelty which characterize the invention, are pointed out with particularity in the claims annexed to and forming a part of this disclosure. For a better understanding of the invention, its operating advantages and the specific objects attained by its uses, reference should be made to the accompanying drawings and descriptive matter which contains illustrated preferred embodiments of the invention.

### BRIEF DESCRIPTION OF THE DRAWINGS

FIGS. 1a-c Isometric, top and front cutaway views, respectively, of the invention in context.

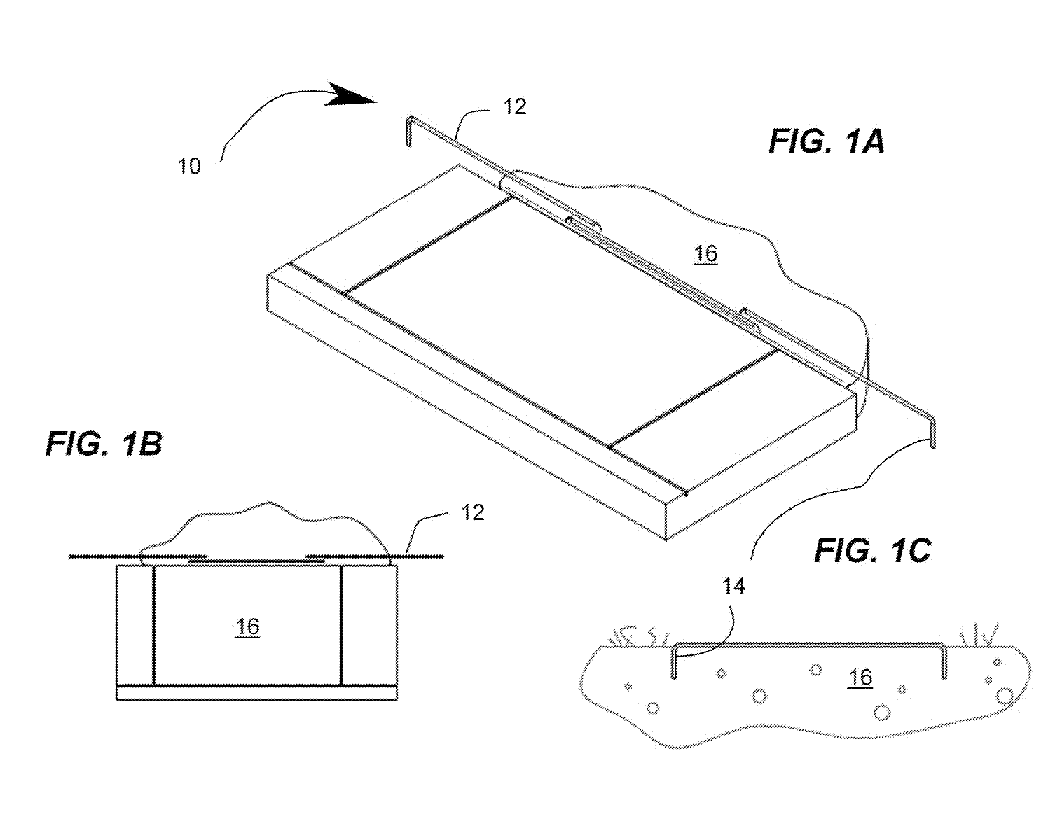

FIGS. 2a-c Isometric, top and front views, respectively, of the invention.

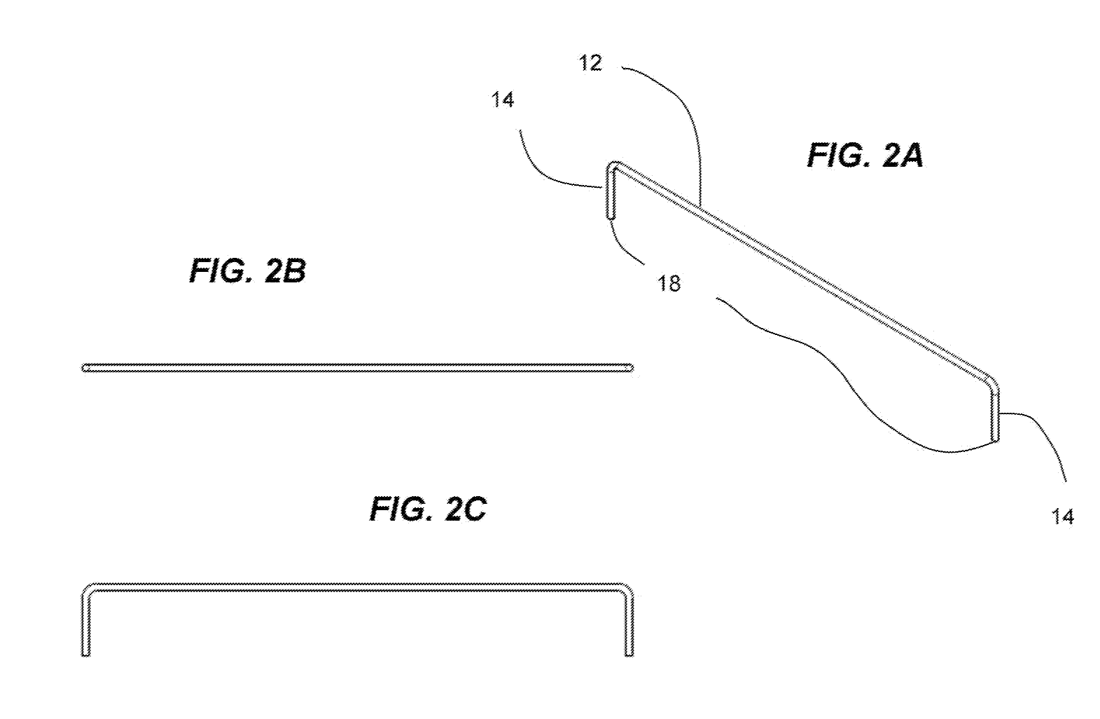

### DETAILED DESCRIPTION

A protective rod (10) for landscape consists in a horizontal member (12) defining a given length, and a pair of anchor members (14) extending perpendicularly from each opposite ends thereof and defining a given height.

The anchor members (14) having generally pointy ends (18) that are planted into the soil (16) of an area to be protected, such as a lawn, for example.

The horizontal members (12) are always above ground whereas the anchor members are partially or totally buried into the ground. The horizontal members (12) come in different lengths as do the anchor members (14) such that the lengths and heights of the the protective rods (10) can also be varied.

The rods (10) can be made of metal or polymer.

The rods (10) are planted into a soft soil by either foot pressure or a mallet.

With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

1. A protective rod for landscape consisting in a horizontal, above ground member defining a given length, and a pair of anchor members extending perpendicularly from each opposite ends thereof and defining a given height.

2. The protective rod for landscape of claim 1 wherein said anchor members have generally pointy ends that are planted in the soil of an area to be protected.

3. The protective rod for landscape of claim 1 wherein said rods are made of metal or polymer.
